(19) United States
(12) Patent Application Publication
(10) Pub. No.: US 2015/0206624 A1
(43) Pub. Date: Jul. 23, 2015

(54) INSULATING WINDING WIRE HAVING CORONA RESISTANCE

(71) Applicant: LS Cable & System Ltd., Anyang-si (KR)

(72) Inventors: Hyung-Sam CHOI, Seoul (KR); Joon-Hee LEE, Gunpo-si (KR); Chang-Kwon KONG, Gumi-si (KR); Jae-Wan PARK, Daegu (KR); Ki-Hong PARK, Bucheon-si (KR)

(73) Assignee: LS Cable & System Ltd., Anyang-si (KR)

(21) Appl. No.: 14/161,946

(22) Filed: Jan. 23, 2014

(51) Int. Cl. H01B 7/02

(52) U.S. Cl. CPC H01B 7/0225

(57) ABSTRACT

The present invention relates to an insulating winding wire and, more particularly, to an insulating winding wire having corona resistance that has an insulation coating excellent not only in corona resistance but also in adhesion and flexibility.

### BACKGROUND OF THE INVENTION

1. Field of the Invention

The present invention relates to an insulating winding wire and, more particularly, to an insulating winding wire having corona resistance that has an insulation coating excellent not only in corona resistance but also in adhesion and flexibility.

2. Background Art

The insulating winding wire refers to a coated insulating winding wire used to wrap an electronic device such as a transformer or the like. The conductor for the insulating winding wire as used herein is chiefly made of copper or aluminum that has high conductivity. For large-sized electrical equipment, a flat type winding wire is used. Further, a round type winding wire which is in wide use is a copper wire having a diameter of 0.025 to 3.2 mm. For insulation, the winding wires are mostly coated with an insulating tape or stripe in the early stage. But there has been a rapid increase in the use of enameled wires along with the development of chemical industries.

The enameled wire refers to a copper wire coated with multiple layers of enamel insulation and heated at high temperature. The enameled wire has the merit of forming a thin coating, providing high insulation and good thermal stability and not being deformed due to its resistance to chemicals. Therefore, the enameled wire is mainly applied to generate the electromagnetic force and widely used as a winding wire for constructing electrical equipment using the electromagnetic force, such as transformers, motors, etc. Depending on the enamel material, the enameled wire includes formal wires, polyurethane wires, polyester wires, heat resistant synthetic enameled wires, oil-based enameled wires, and so forth.

When the insulating winding wire including the enameled wire applied to a high-voltage motor has poor corona resistance, the localized electric field is concentrated at the tiny gaps between the insulation coatings or inside the insulation coating. This can result in partial discharge of electrical energy called corona discharge or corona.

The charged particles generated as a result of the corona discharge conflict with one another to generate heat and damage the insulation coating to break down, causing a breakdown of insulation. With a recent trend of using the systems with inverter-driven motors for the purpose of energy conservation, there are a growing number of cases that a breakdown of insulation takes place due to the inverter serge in the systems using inverter-driven motors. It has proved that such a breakdown of insulation associated with the inverter serge comes down to the corona discharge which is caused by the overvoltage with the inverter serge.

There has been suggested an enameled wire which is made by adding inorganic insulation particles, such as silica, titanium dioxide, etc., to an insulation coating resin in order to provide the insulating wires with corona resistance. In addition to providing corona resistance for the enameled wires, the inorganic insulation particles contribute to promotion of heat conductivity and strength and reduction of thermal expansion.

An increase in the content of the inorganic insulation particles improves corona resistance but also leads to deterioration in the adhesion between the conductor and the insulation coatings and the flexibility of the coatings. For this reason, when a winding wire containing a great amount of inorganic insulation particles in the insulation coatings is used in the construction of coils for electrical equipment, it possibly causes a number of cracks in the insulation coatings and eventually makes it difficult to acquire the effect of corona resistance, which is the genuine object of using the inorganic insulation particles. This problem is accentuated when the inorganic insulation particles exist in the layer of the insulation coatings closer to the conductor.

To overcome the problem, an insulating wire having corona resistance with a multi-layered structure is generally used. FIG. 1 is a schematic view showing a cross section of the insulating wire having corona resistance with a multi-layered structure. As shown in FIG. 1, a general insulating wire having corona resistance with a multi-layered structure includes a conductor 1 and an insulation coating. The insulation coating includes a basal layer 2 made of a resin having good adhesiveness and disposed to cover around the conductor 1; an outer layer 4 covering around the basal layer 2 and containing inorganic insulation particles 3 dispersed in a resin excellent in mechanical strength; and an outermost layer 5 disposed to cover around the outer layer 4 and made of a self-lubricating resin to make the surface of the winding wire smooth.

The conventional insulating wire having corona resistance with a multi-layered structure includes the inorganic insulation particles 3 in the outer layer 4 in order to prevent deterioration in the adhesion of the basal layer 2 with the conductor and the flexibility of the coating when the inorganic insulation particles 3 are contained in the basal layer 2 particularly required to have corona resistance. Further, when the content of the inorganic insulation particles 3 dispersed in the resin constituting the outer layer 4 is 20 parts by weight or less with respect to 100 parts by weight of the resin, the insulating wire has poor corona resistance. The content of the inorganic insulation particles 3 greater than 25 parts by weight not only deteriorates the flexibility of the coating, unavoidably causing cracks in the coating during elongation, but also causes a settling of the inorganic insulation particles 3 to make the surface of the insulating wire rough and deteriorate insulation withstanding voltage and mechanical properties.

Accordingly, there is a demand for an insulating winding wire having corona resistance with an insulation coating that exhibits good corona resistance but does not deteriorate in terms of the adhesion between the conductor and the insulation coating and the flexibility of the coating when compared with the general insulating wires.

### SUMMARY OF THE INVENTION

It is therefore an object of the present invention to provide an insulating winding wire having corona resistance that includes an insulation coating excellent in corona resistance.

It is another object of the present invention to provide an insulating winding wire excellent not only in corona resistance but also in the adhesion between the conductor and the insulation coating and the flexibility of the coating.

To achieve these objects, the present invention provides the insulating winding wire having corona resistance, comprising a conductor and an insulation coating, the insulation coating comprising a basal layer applied to cover the conductor and an outer layer applied to cover the basal layer, the basal layer comprising at least one resin selected from the group consisting of polyvinylformal resin, polyurethane resin, heat-resistant polyurethane resin, polyester resin, polyester imide resin, polyamide imide resin, polyimide resin, and polyamide resin, the basal layer comprising 5 to 15 parts by weight of inorganic insulation particles and 1 to 3 parts by weight of an adhesive agent with respect to 100 parts by weight of the resin, the basal layer having a thickness 70 to 80% of the thickness of the insulation coating, the outer layer comprising at least one resin selected from the group consisting of polyvinylformal resin, polyurethane resin, heat-resistant polyurethane resin, polyester resin, polyester imide resin, polyamide imide resin, polyimide resin, and polyamide resin.

In accordance with one embodiment of the invention, the basal layer may comprise a polyester imide resin, the outer layer comprising a polyamide imide resin. Also, the inorganic insulation particles may comprise at least one selected from the group consisting of silica, alumina, titanium dioxide, zirconia, yttria, mica, clay, chromium oxide, zinc oxide, iron oxide, magnesium oxide, calcium oxide, scandium oxide and barium oxide. Furthermore, the insulation coating may further comprise an outermost layer being applied to cover the outer layer and comprising a self-lubricating resin.

In another embodiment, the self-lubricating resin may be self-lubricating polyamide imide. Also, the adhesive agent may comprise at least one adhesive agent selected from the group consisting of a melamine-based adhesive agent, an amine-based adhesive agent, a mercaptan-based adhesive agent, and a polycarbodiimide adhesive agent. Furthermore, the conductor may be a copper wire having a round or flat cross section. Meanwhile, the conductor may have a round cross section having a diameter of 0.3 to 3.2 mm, the insulation coating having a thickness of 40 to 103 μm.

### Effects of the Invention

The insulating winding wire having corona resistance according to the present invention includes inorganic insulation particles in a basal layer in contact with a conductor in an insulation coating and has the thickness of the basal layer increased not only to provide corona resistance but also to enhance the adhesion between the conductor and the insulation coating and the flexibility of the coating.

Further, the insulating winding wire having corona resistance according to the present invention further includes an adhesive agent for additionally providing the basal layer with adhesiveness, thereby effectively enhancing the adhesion between the conductor and the insulation coating.

Furthermore, the insulating winding wire having corona resistance according to the present invention uses a self-lubricating resin to form the outermost layer out of the insulation coating and thus has a good effect to make the surface of the winding wire smooth.

### BRIEF DESCRIPTION OF THE DRAWINGS

FIG. 1 is a schematic diagram showing a cross section of a conventional insulating wire having corona resistance with a multi-layered structure.

FIG. 2 illustrates an exemplary embodiment showing the structure of an insulating winding wire having corona resistance according to the present invention.

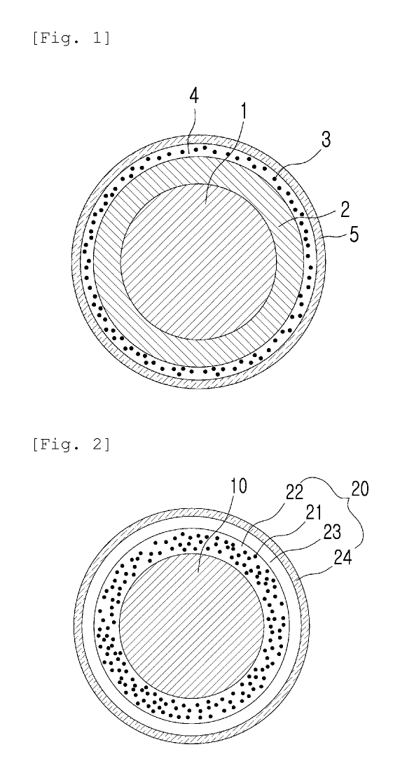

### DETAILED DESCRIPTION OF THE PREFERRED EMBODIMENT

Hereinafter, preferred embodiments of the present invention will be described in further detail with reference to the accompanying drawings. The present invention may, however, be embodied in many different forms and should not be construed as limited to the embodiments set forth herein. Rather, these embodiments are provided so that this disclosure will be thorough and complete, and fully convey the scope of the invention to those skilled in the art. Throughout the specification, the same reference numbers may be used to denote similar components in various embodiments.

FIG. 2 illustrates an exemplary embodiment showing the structure of an insulating winding wire having corona resistance according to the present invention. As shown in FIG. 2, the insulating winding wire having corona resistance includes a round-shaped conductor 10 and an insulation coating 20. The insulation coating 20 includes a basal layer 22 being made of a resin having good adhesiveness and containing inorganic insulation particles 21 dispersed therein, and an outer layer 4 made of a resin excellent in heat resistance and mechanical properties and disposed in contact with the basal layer 22. The insulation coating 20 further includes an outermost layer 24 made of a self-lubricating resin to make the surface of the winding wire smooth.

The thickness and the structure of the conductor 10 and the insulation coating 20 may be as defined in the KS standards (KS C 3107). According to the KS standards, the diameter of the conductor 10 ranges from 0.3 mm to 3.2 mm. Further, the standard coating thickness (the average value of the maximum and minimum coating thicknesses) of the insulation coating 20 increases with an increase in the diameter of the conductor 10. More specifically, the standard coating thickness is 10 to 31 μm for the type 2; 14 to 169 μm for the type 1; and 21 to 194 μm for the type 0.

The shape of the conductor constituting the insulating winding wire having corona resistance according to the present invention is not confined to the example illustrated in the exemplary embodiment and may be appropriately changed or selected depending on the use purpose of the insulating winding wire within the range for those skilled in the related art of the present invention (hereinafter, referred to as “those skilled in the art”) to achieve the objects of the present invention.

The conductor 10 is mostly made of a copper or aluminum material that has high conductivity, preferably a copper material. Further, the insulation coating 20 is usually made of a polymer resin, which will be described later.

The resin that forms the insulation coating 20 may include at least one resin selected from the group consisting of polyvinylformal resin, polyurethane resin, heat-resistant polyurethane resin, polyester resin, polyester imide resin, polyamide imide resin, polyimide resin, polyamide resin, and so forth.

Furthermore, the insulation coating 20 may have a multi-layered structure of a same resin or different resins, as shown in FIG. 2. Out of the insulation coating 20, the basal layer 22 disposed in contact with the conductor 10 is preferably made of a polyester resin, a polyester imide resin, etc. which is excellent in the flexibility of the coating and the adhesion with the conductor; and the outer layer 23 is made of a polyamide imide resin, etc. that is somewhat poor in flexibility but excellent in heat resistance and mechanical strength. This can provide the insulating winding wire of the present invention with excellences in the flexibility when bending such as winding the wire, the adhesion between the conductor and the insulation coating, and the mechanical strength of the winding wire.

On the other hand, the insulating winding wire according to the present invention includes inorganic insulation particles 21 in the basal layer 22 other than outer layers 23 and out of the insulation coatings 20 and 40, thereby having a good effect to acquire corona resistance. The inorganic insulation particles 21 may include at least one inorganic insulation particle selected from the group consisting of silica, alumina, titanium dioxide, zirconia, yttria, mica, clay, chromium oxide, zinc oxide, iron oxide, magnesium oxide, calcium oxide, scandium oxide, barium oxide, etc.

The methods for preparing a resin containing the inorganic insulation particles 21 dispersed therein are already known. For example, the methods may employ the ball-milling method as disclosed in U.S. Pat. No. 6,403,890; the mechanical method based on high shear mixing in U.S. Pat. No. 4,493,873; the simple agitation method in U.S. Pat. No. 6,180,888; and the sol-gel method in JP Laid-Open Publication No. 2003-36731.

In order to effectively acquire corona resistance, the inorganic insulation particles 21 are required to have good dispersion properties, ultrafine size range, preferably from 4 nm to 100 nm, high specific surface area (BET method), preferably 100 to 300 m²/g, high purity, preferably 95% or above, spherical particle shape, pore-free property, and so forth. There are various known methods for improving these properties.

For example, German Patent No. 4209964 discloses an inorganic insulation particle of which the surface is modified, such as silanized in order to be easily dispersed in a resin. More specifically, the surface-silanized inorganic insulation particles can be prepared by adding the inorganic insulation particles to a solvent, such as toluene, xylene, ethanol, cresol, etc., to prepare a mixture solution and then adding a silane compound, such as amine-based silane, phenyl-based silane, aniline-based silane, silane having a hydrocarbon functional group, etc. to the mixture solution to cause silanization.

In the present invention, the content of the inorganic insulation particles 21 may be in the range of 5 to 15 parts by weight with respect to 100 parts by weight of the resin which contains the inorganic insulation particles 21. The content of the inorganic insulation particles 21 less than 5 parts by weight is too insignificant to provide corona resistance, while the content of the inorganic insulation particles 21 greater than 15 parts by weight leads to deterioration in the adhesion between the conductor and the insulation coating and the flexibility of the coating. The thickness of the basal layer 22 in which the inorganic insulation particles 21 are dispersed may be 70 to 80% of the total thickness of the insulation coating 20.

In other words, the inorganic insulation particles 21 are contained in the basal layer 22 closest to the conductor in order to provide the corona resistance to the maximum. In this case, the insulating winding wire can acquire good corona resistance even when it contains a small amount of the inorganic insulation particles, in relation to the conventional multi-layered insulating wire which contains inorganic insulation particles in the outer layer rather than the basal layer.

Further, the thickness of the basal layer 22 is increased to be greater than the thickness of the basal layer constituting the conventional multi-layered insulating wire (for example, about 50% of the total thickness of the insulation coating) in order to minimize or prevent the possible damages on the adhesion of the basal layer 22 with the conductor and the flexibility of the coating caused by the addition of the inorganic insulation particles 21. In this manner, the weight ratio of the inorganic insulation particles 21 with respect to 100 parts by weight the resin constituting the basal layer 22 is reduced to 5 to 15 parts by weight, which is lower than the typical weight ratio of the inorganic insulation particles included in the conventional insulating wire (for example, 20 to 25 parts by weight with respect to 100 parts by weight of the resin in the outer layer). This can result in enhanced properties, such as the adhesion between the conductor and the insulation coating, the flexibility of the coating, and so forth. At the same time, the absolute amount of the inorganic insulation particles 21 included in the basal layer 22 becomes not less than, equal to, or greater than the weight of the inorganic insulation particles included in the conventional insulating wire, thereby greatly enhancing the corona resistance of the insulating winding wire.

As shown in FIG. 2, the insulation coating 20 of the insulating winding wire having corona resistance according to the present invention may further include the outermost layer 24 made of a self-lubricating resin. The self-lubricating property implies having a low frictional resistance, namely, having a smooth surface. The self-lubricating resin can be prepared by introducing a self-lubricating functional group into the main chain of a polymer. For example, a self-lubricating polyamide imide resin is prepared by polymerizing trimellitic anhydride, aromatic diisocyanate, and amino siloxane at a predetermined equivalent weight ratio to obtain polyamide carbamate as an intermediate compound, imidizing the polyamide carbamate, and then adding an aromatic hydrocarbon as a solvent for controlling the viscosity. On the other hand, the outermost layer 24 may be formed by adding a self-lubricating agent, such as ethylene, graphite, etc., to a polyamide imide resin or the like. In this regard, the content of the self-lubricating agent may be in the range of 1 to 10 parts by weight with respect to 100 parts by weight of the resin.

In addition, the insulating winding wire having corona resistance according to the present invention may further include an adhesive agent, that is, an adhesion enhancing agent to the basal layer 22 out of the insulation coating 20. The adhesive agent further enhances the adhesion between the basal layer 22 and the conductor 10 to effectively provide corona resistance. The adhesive agent as used herein may be selected from melamine-based adhesive agents such as alkoxy (e.g., butoxy) melamine resin; amine-based adhesive agents such as trialkyl amine, etc.; mercaptan-based adhesive agents such as mercaptobenzimidazole, etc.; polycarbodiimide adhesive agents, and so forth. The content of the adhesive agent may be in the range of 1 to 3 parts by weight with respect to 100 parts by weight of the resin constituting the basal layer 22.

The resins, the inorganic particles, and the adhesive agents used in the following examples and comparative examples are given as follows:

Resin paint 1: Polyester imide (GPEI-39, Kunsul Chemical Industrial Co., Ltd.) having a solid concentration of 39 wt. %

Resin paint 2: Polyamide imide (GM-38K, KOMEC Co., Ltd.)

Resin paint 3: Self-lubricating polyamide imide (KPAI-27S, KOMEC Co., Ltd.)

Inorganic particles: Silica

Adhesive agent: Alkoxy melamine-based adhesive agent

### Example 1

To 15 kg of a resin paint are added 292 g of inorganic particles (about 5 parts by weight with respect to 100 parts by weight of the solid resin in the resin paint) and 58.5 g of an adhesive agent. The mixture is blended with a high-speed agitator (JS-MILL; NCTech Ltd.) to obtain an insulation paint. The inorganic particle-dispersed insulation paint is applied on a ring-shaped copper conductor having a diameter of 1.1 mm by way of a coating/application device (SICME NEV, Italy) and then cured at a linear velocity of 32 m/min in a baking furnace at 360 to 560° C. to form a basal layer to a coating thickness of 30 μm. The resin paint 1 and the resin paint 2 are sequentially applied onto the basal layer according to the above-described procedure to form an outer layer and an outermost layer to a coating thickness of 10 μm. As a result, an insulating winding wire having corona resistance is completed to a final coating thickness of 40 μm.

### Example 2

The procedures are performed to prepare an insulating winding wire in the same manner as described in Example 1, excepting that the inorganic particles are added in an amount of 585 g (about 10 parts by weight with respect to 100 parts by weight of the solid resin in the resin paint).

### Example 3

The procedures are performed to prepare an insulating winding wire in the same manner as described in Example 1, excepting that the inorganic particles are added in an amount of 878 g (about 15 parts by weight with respect to 100 parts by weight of the solid resin in the resin paint).

### Comparative Example 1

The procedures are performed to prepare an insulating winding wire in the same manner as described in Example 3, excepting that the adhesive agent is not used.

### Comparative Example 2

The procedures are performed to prepare an insulating winding wire in the same manner as described in Example 1, excepting that the adhesive agent is not used.

### Comparative Example 3

The procedures are performed to prepare an insulating winding wire in the same manner as described in Example 1, excepting that the inorganic particles are added in an amount of 176 g (about 3 parts by weight with respect to 100 parts by weight of the solid resin in the resin paint).

### Comparative Example 4

The procedures are performed to prepare an insulating winding wire in the same manner as described in Example 2, excepting that the thickness of the basal layer is 20 μm, with the total thickness of the outer layer and the outermost layer being 20 μm).

### Comparative Example 5

The resin paint 1 is applied on a ring-shaped copper conductor having a diameter of 1.1 mm by way of a coating/application device (SICME NEV, Italy) and then cured at a linear velocity of 32 m/min in a baking furnace at 360 to 560° C. to form a basal layer to a coating thickness of 30 μm. To 15 kg of the paint resin 2 is then added 1012 g (about 25 parts by weight with respect to 100 parts by weight of the solid resin in the resin paint). The resultant mixture is blended with a high-speed agitator (JS-MILL; NCTech) to obtain an insulation paint. In the same procedures, the insulation paint containing organic particles dispersed therein and the resin paint 3 are sequentially applied to the basal layer three times and then cured to form an outer layer and an outermost layer to a coating thickness of 10 μm. As a result, an insulating winding wire having corona resistance is completed to a final coating thickness of 40 μm.

<Evaluation of Coating Flexibility>

The specimen of each insulating winding wire prepared in the Examples and Comparative Examples is wound around a polished mandrel having a predetermined diameter continuously thirty times or more. In terms of the coating flexibility, the coating flexibility is determined as “good” when the specimen has no crack and “bad” when the specimen has cracks.

<Evaluation of Adhesion>

The specimen of each insulating winding wire prepared in the Examples and Comparative Examples is rapidly stretched out to a predetermined length. After elongation, the results of observation are recorded concerning occurrence of cracks or adhesion loss in the specimen. More specifically, when the specimen has cracks, the length of the conductor at the breaking point is determined as the shrinkage length; and the gap length between the conductor at the breaking point and the insulation coating is determined as the coating gap length.

<Peel Test>

The specimen of each insulating winding wire prepared in the Examples and the Comparative Examples is fixed at both ends each with a fixture. The fixture at the one end is free to rotate, and the fixture at the other end is not free to rotate but capable of being moved in the axis direction, applying a defined load to the winding wire. After fixing the specimen, the coating on the one side is peeled off along the axis of the insulating winding wire, and the winding wire is rotated in the direction of its axis until the insulation coating gets cracks. The number of rotation times when the first crack occurs is recorded. The winding wire is evaluated as “good” in the peel test when the number of rotation times is 100 or greater.

<Evaluation of Breakdown Voltage>

A pair of specimens of each insulating winding wire prepared in the Examples and the Comparative Examples are twisted at the one end with a defined load to prepare a specimen twisted with two stripes. A test voltage is then applied between the conductors to determine the voltage at which the insulation coating of the specimen is broken. Generally, the winding wire is evaluated as “good” in terms of the breakdown voltage when the breakdown voltage is 8,000 V or higher.

<Evaluation of Softening Resistance>

A pair of specimens of each insulating winding wire prepared in the Examples and the Comparative Examples are inserted into a metal block preheated at a predetermined temperature so that they intersect at right angles. A predetermined alternating current (AC) voltage is applied between the metal block and the specimens. Then, the metal block is heated to determine the temperature at which a short circuit occurs. Generally, the winding wire is evaluated as “good” in terms of the softening resistance when the temperature for the short circuit to occur is 350° C. or higher.

<Evaluation of Corona Resistance>

A pair of specimens of each insulating winding wire prepared in the Examples and the Comparative Examples are twisted at the one end with a defined load to prepare a specimen twisted with two stripes. Subsequently, a voltage having a frequency of 20 kHz and a sine curve of 2.0 kVp is applied to both ends of the specimen to determine the pulse endurance time taken to cause a short circuit. Generally, the winding wire is evaluated as “good” in terms of the corona resistance when the pulse endurance time is 2 hours or longer.

The evaluation results for the Examples and the Comparative Examples are presented in Table 1 below.

TABLE 1

| | | Example | | |
|---|---|---|---|---|
| | | 1 | 2 | 3 |
| Coating flexibility | | Good | Good | Good |
| Adhesion | Cracks | Good | Good | Good |
| property | Shrinkage length (mm) | 0.55 | 0.7 | 0.7 |
| | Coating gap (mm) | 1.25 | 1.35 | 1.75 |

| | | | |
|---|---|---|---|
| Peel test (number of times) | 135 | 127 | 117 |
| Breakdown voltage (V) | 12000 | 11000 | 11600 |
| Softening resistance (° C.) | 440 | 450 ↑ | 450 ↑ |
| Corona resistance (the number | 2 h 15 min | 3 h 10 min | 7 h 30 min |
| of times) | | | |
| Acceptance/rejection | Accepted | Accepted | Accepted |

| | | Comparative Example | | | | |
|---|---|---|---|---|---|---|
| | | 1 | 2 | 3 | 4 | 5 |
| Coating flexibility | | Good | Good | Good | Good | Bad |
| Adhesion | cracks | Good | Good | Good | Good | Cracks |
| property | Shrinkage length (mm) | 2.5 | 0.45 | 0.55 | 0.7 | 0.65 |
| | Coating gap (mm) | 1.5 | 1.25 | 1.25 | 1.75 | 1.25 |

| | | | | | |
|---|---|---|---|---|---|
| Peel test (number of times) | 77 | 141 | 138 | 115 | 135 |
| Breakdown voltage (V) | 12500 | 8220 | 10500 | 10800 | 8720 |
| Softening resistance (° C.) | 450 ↑ | 393 | 425 | 450 ↑ | 383 |
| Corona resistance (the number | 9 h 30 min | 10 min | 42 min | 1 h 50 min | 35 min |
| of times) | | | | | |
| Acceptance/Rejection | Rejected | Rejected | Rejected | Rejected | Rejected |

As can be seen from Table 1, the insulating winding wires prepared in the Examples 1, 2 and 3 are insulating winding wires having corona resistance excellent not only in corona resistance, which is the genuine object of the insulating winding wire, but also in the adhesion between the conductor and the insulation coating and the flexibility of the coating.

The evaluation results in Table 1 reveals that the insulating winding wires having corona resistance according to the present invention (Examples 1, 2 and 3) maintain the adhesion properties and improve in the corona resistance and the flexibility of the coating, in comparison with the conventional insulating winding wires having corona resistance with a multi-layered structure (Comparative Examples 1 to 5).

More specifically, the insulating winding wire prepared in the Example 1 contains inorganic insulation particles in the basal layer in an amount of 5 parts by weight with respect to 100 parts by weight of the resin. In consideration of the coating thickness of the basal layer, the content of the inorganic insulation particles in the winding wire of the Example 1 actually amounts to 15 parts by weight, because the thickness of the basal layer containing the inorganic insulation particles is three times greater than the thickness of the outer layer containing inorganic insulation particles in the Comparative Example 5. In relation to the insulating winding wire of the Comparative Example 5 which contains inorganic insulation particles at an amount of 20 parts by weight or greater, in consideration of the total coating thickness, the insulating winding wire of the Example 1 has a relatively low content of the inorganic insulation particles but exhibits good corona resistance because it contains the inorganic insulation particles in the basal layer disposed in contact with the conductor.

Further, the insulating winding wires prepared in the Examples 2 and 3 contain inorganic insulation particles in the basal layer in an amount of 10 parts by weight and 15 parts by weight, respectively, with respect to 100 parts by weight of the resin. In the matter of fact, the content of the inorganic insulation particles in the winding wires of the Examples 2 and 3 amounts to 30 parts by weight and 45 parts by weight, respectively, since the thickness of the basal layer containing the inorganic insulation particles in each winding wire is three times greater than the thickness of the outer layer containing inorganic insulation particles in the Comparative Example 5. In comparison with the insulating winding wire of the Comparative Example 5, the insulating winding wires of the Examples 2 and 3 have a higher content of the inorganic insulation particles, which are contained in the basal layer, thereby securing good corona resistance. The insulating winding wires of the Examples 2 and 3 are also superior in the flexibility of the coating, because of the smaller number of the inorganic insulation particles per unit coating area, that is, the lower density of the inorganic insulation particles in the coating.

The insulating winding wire of the Comparative Example 1 is prepared in the same manner as described in the Example 3, excepting that the adhesive agent is not added to the basal layer. It is excellent in corona resistance, adhesiveness, and coating flexibility but a little bit inferior in the peel properties to the insulation winding wire of the Example 3.

Contrarily, the insulation winding wire prepared in the Comparative Example 2 which does not contain the inorganic insulation particles is excellent in the adhesion between the conductor and the insulation coating and the flexibility of the insulation coating but poor in corona resistance. The insulation winding wire prepared in the Comparative Example 3 contains the inorganic insulation particles at an amount of 3 parts by weight, which is less than 5 parts by weight, with respect to 100 parts by weight of the resin constituting the basal layer, so it cannot acquire sufficiently good corona resistance.

On the other hand, the insulating winding wire of the Comparative Example 4 is prepared in the same manner as described in the Example 2, excepting that the thickness of the basal layer is smaller. The insulating winding wire contains 10 parts by weight of the inorganic insulation particles with respect to 100 parts by weight of the resin constituting the basal layer and has the basal layer formed to a smaller thickness, so it actually has the lower content of the inorganic insulation particles than the insulating winding wire of the Example 2. It is therefore concluded that the corona resistance of the insulating winding wire of the Comparative Example 4 is not good enough. In addition, the insulating winding wire of the Example 1 has the same content of the inorganic insulation particles of the Comparative Example 4 when the total coating thickness is taken into consideration. It has the lower density of the inorganic insulation particles but exhibits higher corona resistance, because the basal layer containing the inorganic insulation particles is formed to the greater thickness.

Moreover, even though the insulating winding wire of the Comparative Example 5 contains the inorganic insulation particles in an amount of 20 parts by weight or greater with respect to 100 parts by weight of the resin, the inorganic insulation particles are included in the outer layer less than 10 μm in thickness. So, the absolute weight of the inorganic insulation particles actually included in the insulating winding wire of the Comparative Example 5 is less than the weight of the inorganic insulation particles in the insulating winding wire of the Example 2 or 3. Furthermore, the inorganic insulation particles are contained in the outer layer not in contact with the conductor, which makes it difficult to effectively acquire corona resistance. For this reason, the insulating winding wire prepared in the Comparative Example 5 is considered to be not good enough in terms of the corona resistance.

The present invention has been described with reference to the preferred exemplary embodiments of the present invention, and it would be understood by those skilled in the art that various changes and modifications may be made without departing from the technical conception and essential features of the present invention. Thus, it is clear that all modifications are included in the technical scope of the present invention as long as they include the components as claimed in the claims of the present invention.

1. An insulating winding wire having corona resistance, comprising a conductor and an insulation coating,
the insulation coating comprising a basal layer applied to cover the conductor and an outer layer applied to cover the basal layer,
the basal layer comprising at least one resin selected from the group consisting of polyvinylformal resin, polyurethane resin, heat-resistant polyurethane resin, polyester resin, polyester imide resin, polyamide imide resin, polyimide resin and polyamide resin,
the basal layer comprising 5 to 15 parts by weight of inorganic insulation particles and 1 to 3 parts by weight of an adhesive agent with respect to 100 parts by weight of the resin,
the basal layer having a thickness 70 to 80% of the thickness of the insulation coating,
the outer layer comprising at least one resin selected from the group consisting of polyvinylformal resin, polyurethane resin, heat-resistant polyurethane resin, polyester resin, polyester imide resin, polyamide imide resin, polyimide resin and polyamide resin.

2. The insulating winding wire having corona resistance as claimed in claim 1, wherein the basal layer comprises a polyester imide resin, and the outer layer comprises a polyamide imide resin.

3. The insulating winding wire having corona resistance as claimed in claim 1, wherein the inorganic insulation particles comprise at least one selected from the group consisting of silica, alumina, titanium dioxide, zirconia, yttria, mica, clay, chromium oxide, zinc oxide, iron oxide, magnesium oxide, calcium oxide, scandium oxide and barium oxide.

4. The insulating winding wire having corona resistance as claimed in claim 1, wherein the insulation coating further comprises an outermost layer being applied to cover the outer layer and comprising a self-lubricating resin.

5. The insulating winding wire having corona resistance as claimed in claim 4, wherein the self-lubricating resin is self-lubricating polyamide imide.

6. The insulating winding wire having corona resistance as claimed in claim 1, wherein the adhesive agent comprises at least one adhesive agent selected from the group consisting of a melamine-based adhesive agent, an amine-based adhesive agent, a mercaptan-based adhesive agent and a polycarbodiimide adhesive agent.

7. The insulating winding wire having corona resistance as claimed in claim 1, wherein the conductor is a copper wire having a round or flat cross section.

8. The insulating winding wire having corona resistance as claimed in claim 7, wherein the conductor has a round cross section having a diameter of 0.3 to 3.2 mm, and the insulation coating having a thickness of 40 to 103 μm.
